(19) United States
(12) Patent Application Publication
(10) Pub. No.: US 2019/0021503 A1
(43) Pub. Date: Jan. 24, 2019

(54) HEADREST ADJUSTMENT DEVICE

(71) Applicant: Dongguan Weihong Hardware and Plastic Products Co., Ltd., Dongguan (CN)

(72) Inventor: Wei Lu, Dongguan (CN)

(21) Appl. No.: 16/142,931

(22) Filed: Sep. 26, 2018

(30) Foreign Application Priority Data
Jul. 5, 2018 (CN) 201821065906.1

(51) Int. Cl. A47C 7/38; F16H 21/54; F16H 21/04; F16H 21/50

(52) U.S. Cl. CPC A47C 7/38; F16H 21/50; F16H 21/04; F16H 21/54

(57) ABSTRACT

A headrest adjustment device includes a linear drive device, a linkage member and an adjustment assembly which includes a fixing member and a headrest bracket. The linkage member is fixed with the headrest bracket and provided with a buffer groove, and the linear drive device has an output rod for linear reciprocating motion. One end of the output rod is connected to one end of the buffer groove, and an angle is formed between the buffer groove and the output rod. The output rod pushes the linkage member to adjust the position and the angle of the headrest, or pulls back the linkage member to fold the headrest. When the headrest is folded, if the hand hinders the headrest movement, the linkage member will move in opposite directions, so that the headrest does not continue to lower which reduces the risk of one's hand injuries.

### RELATED APPLICATIONS

This application claims the benefit of priority to Chinese Utility Model Application No. 201821065906.1 filed on Jul. 5, 2018, which is hereby incorporated by reference in its entirety.

### FIELD OF THE INVENTION

The present invention relates to a field of furniture parts, more particularly to a headrest adjustment device for preventing one's hand from being pinched and protecting one's hand from injury.

### BACKGROUND OF THE INVENTION

Generally, angles of a headrest of a sofa can be adjusted to improve comfort. One of the achievement manners is to set an adjuster having a pivotal joint in the sofa. Generally, a common manner is to set a hinge for connecting the headrest inside a sofa and changing headrest position. Concretely, the headrest is pulled to drive the headrest and an end of hinge rotates together. After the headrest rotates relative to the sofa body by a certain angle, the headrest is located in another position and locked by means of the hinge. Such a configuration allows consumers to adjust the headrest position according to their own needs. However, the headrest must be pulled manually, and it is inconvenient to operate it.

At present, many sofas are equipped with an electric angle adjustment device, which uses a built-in motor as a power source to adjust automatically a headrest angle. Furthermore, a connecting rod, a slide rail and the like are set to pull and guide the headrest, thereby adjusting automatically the headrest angle. Although it is more convenient to adjust the headrest by the electric angle adjustment device, there are certain safety hazards. For example, when the headrest is adjusted to a position close to the sofa body, if hand is under the headrest, the motor continues to move the headrest downward, which will cause accidental injuries to the person.

Thus, in order to improve safety, it's necessary to provide an adjustment device for protect one's hand from injury.

### SUMMARY OF THE INVENTION

One objective of the present invention is to provide an adjustment device for adjusting angle and height of the headrest, which effectively prevents one's hand from being pinched and protects one's hand from injury.

To achieve the above objective, a headrest adjustment device of the present invention includes a linear drive device, a linkage member and an adjustment assembly. The adjustment assembly includes a fixing member and a headrest bracket movably connected with the fixing member. The linkage member is fixed with the headrest bracket and provided with a buffer groove. The linear drive device has an output rod for linear reciprocating motion, one end of the output rod is connected to one end of the buffer groove, and an angle is formed between the buffer groove and the output rod.

In comparison with the prior art, the linear drive device is used as a power source, and the linear motion of the output rod drives the headrest bracket to move relatively to the fixing member through the linkage member, thereby adjusting the headrest angle. When the output rod pushes the linkage member, the headrest bracket is lifted, thereby adjusting the position and the angle of the headrest. When the output rod pulls back the linkage member, the headrest bracket is lowered to fold the headrest. When the headrest is folded, if the hand is placed between the headrest and the sofa body and hinders the headrest movement, the linkage member will move in opposite directions to push one end of the output rod to move to the other end of the buffer groove, so that the headrest does not continue to be pressed down and lowering. Thus, the linear drive device works continuously and greatly reduces the risk of one's hand injuries.

Preferably, two adjustment assemblies with respective headrest bracket are configured oppositely, and the linkage member is fixed between the two headrest brackets.

Concretely, the linkage member includes a linkage rod fixed between the two headrest brackets and a linkage plate fixed on the linkage rod, the buffer groove is defined in the linkage plate, and the linear drive device is located between the two adjustment assemblies.

Preferably, the fixing member is provided with a guide structure, the headrest bracket is slidably disposed on the fixing member by the guide structure, and a sliding track of the headrest bracket is curved.

Concretely, the guide structure includes a plurality of sets of rollers rotatably mounted to a side of the fixing member, and the headrest bracket is curved and inserted into a gap between each set of the rollers.

Preferably, a guide groove is defined on a circumferential surface of the roller, and the headrest bracket is accommodated between two guide grooves of a set of the rollers.

Concretely, the headrest bracket is provided with a first limiting portion that is protruded, and the fixing member is provided with a second limiting portion cooperating with the first limiting portion to limit the headrest bracket.

Preferably, the adjustment assembly further includes an elastic member located between the fixing member and the headrest bracket, which urges the headrest bracket back to a bottommost position.

Preferably, the linear drive device is an electric push rod.

Preferably, the headrest adjustment device further includes a fixing base, and the linear drive device is hinged to the fixing base.

### BRIEF DESCRIPTION OF THE DRAWINGS

The accompanying drawings facilitate an understanding of the various embodiments of this invention. In such drawings:

FIG. 1 is a perspective view of a headrest adjustment device according to one embodiment of the present invention;

FIG. 2 is an exploded view of an adjustment assembly of the headrest adjustment device according to one embodiment of the present invention;

FIG. 3 is a side elevational view of the headrest adjustment device, when the headrest bracket is at the topmost position; and

FIG. 4 is a side elevational view of the headrest adjustment device, when the headrest bracket is at the bottommost position.

### DETAILED DESCRIPTION OF ILLUSTRATED EMBODIMENTS

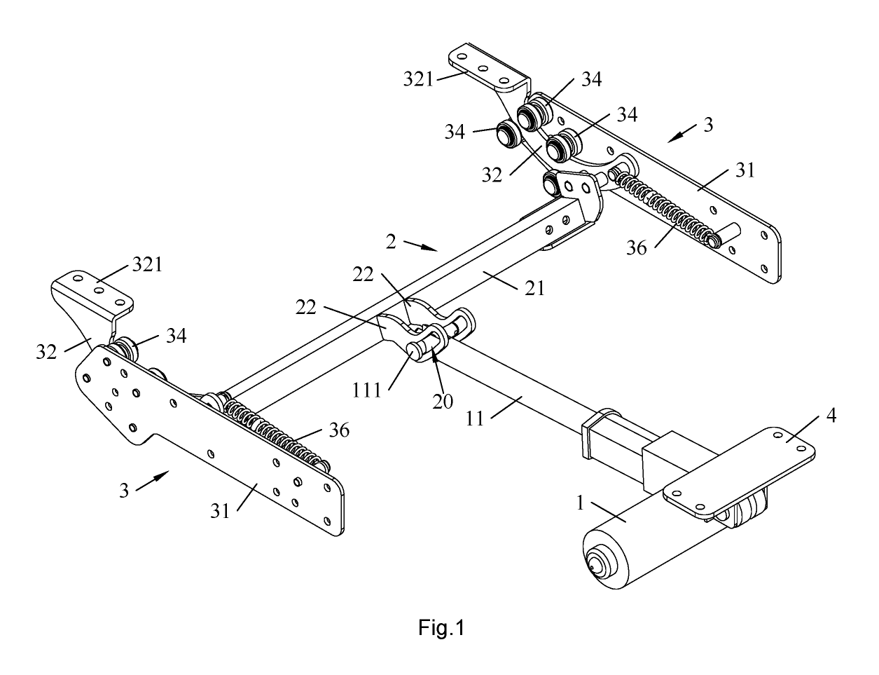

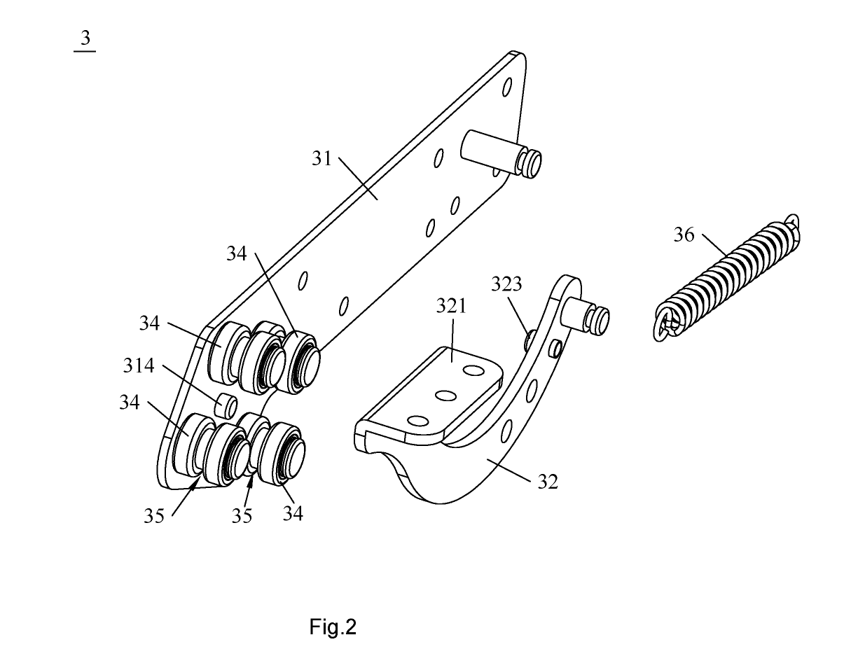

As illustrated in FIGS. 1 and 2, a headrest adjustment device according to one embodiment of the present invention is applicable to be installed between a sofa body and a headrest to adjust the angle and height of the headrest relatively to the sofa body, which can protect one's hand from injury while the headrest is adjusted.

The headrest adjustment device includes a linear drive device 1, a linkage member 2, and an adjustment assembly 3. The adjustment assembly 3 includes a fixing member 31 and a headrest bracket 32 movably connected with the fixing member 31. The fixing member 31 is fixed on the sofa body and the headrest bracket 32 is fixed with the headrest. When the headrest bracket 32 moves relatively to the fixing member 31, the position and the angle of the headrest will be changed. The linear drive device 1 is used as a power source, which has an output rod 11 for linear reciprocating motion. The output rod 11 drives the headrest bracket 32 by the linkage member 2, so the linkage member 2 is fixed to the headrest bracket 32, and movably connected to the output rod 11. A buffer groove 20 is opened on the linkage member 2, and one end of the output rod 11 is connected to one end of the buffer groove 20. Specifically, for example, a pin 111 can be fixed at one end of the output rod 11 and inserted into one end of the buffer groove 20, which allows the output rod 11 to drive the linkage member 2 and also allows the output rod 11 to pivot relatively to the linkage member 2. It is sure that, when the output rod 11 is stretched out to push the linkage member 2, and an angle is formed between the buffer groove 20 and the output rod 11, so that the pin 111 does not generally slide along the buffer groove 20 when the output rod 11 is retracted. The output rod 11 can pull the linkage member 2 back, and only when the linkage member 2 is hindered, the end of the output rod 11 slides relatively to the buffer groove 20.

Preferably, two adjustment assemblies 3 with respective headrest bracket are configured oppositely to ensure stability of the headrest, and the linkage member 2 is fixed between the two headrest brackets 32. The two headrest brackets 32 of the two adjustment assemblies 3 are respectively located at an inner side of the two fixing members 31. The linear drive device 1 and the linkage member 2 are located between the two adjustment assemblies 3. Opposite ends of the linkage member 2 are respectively fixedly connected with the two headrest brackets 32 to synchronously drive the two headrest brackets 32.

Concretely, the linkage member 2 includes a linkage rod 21 fixed between the two headrest brackets 32 and two linkage plates 22 oppositely disposed on the linkage rod 21, and the linkage plate 22 is substantially fixed to an intermediate position of the linkage rod 21. The buffer groove 20 is opened on the linkage plate 22, and one end of the output rod 11 is located between the two linkage plates 22. In this embodiment, the linear drive device 1 is an electric push rod. The torque of the motor is converted into a linear motion of the output rod 11 by a built-in transmission structure, and the linear drive device 1 can also be a cylinder or the like capable of outputting a linear driving force. The headrest adjustment device further includes a fixing base 4. The linear drive device 1 is hinged to the fixing base 4, and the fixing base 4 is fixed to the sofa body so that the linear drive device 1 is installed in the sofa body. Besides, while the output rod 11 is stretched out, the linear drive device 1 can also swing up and down to a certain extent.

Preferably, the fixing member 31 is provided with a guide structure, the headrest bracket 32 is slidably disposed on the fixing member 31 by the guide structure, and a sliding track of the headrest bracket 32 is curved. The angle and the position of the headrest bracket 32 will be adjusted when the headrest bracket 32 slides on the fixing member 31. Concretely, the guide structure includes a plurality of sets of rollers 34 rotatably mounted to a side of the fixing member 31, and the headrest bracket 32 is curved and inserted into a gap between each set of the rollers 34. The number of rollers 34 can be four, namely be in two groups. With the cooperation of the roller 34 and the shape of the headrest bracket 32, the headrest bracket 32 can be arcuately slid. One end of the headrest bracket 32 is fixed to the linkage rod 21, and the other end of the headrest bracket 32 is formed with a mounting portion 321 which is perpendicular to the curved portion and has a flat shape, and the mounting portion 321 is fixed to the headrest. More specifically, a guide groove 35 is defined on the a circumferential surface of the roller 34, and the headrest bracket 32 is accommodated between the two guide grooves 35 of a set of rollers 34, so that the headrest bracket 32 is stably slid between the rollers 34 without being brought close to or away from the fixing member 31. The guide structure on the fixing member 31 may also be other structure than the roller 34. For example, an arc-shaped guide rail or a guide groove may be disposed on the fixing member 31, and the headrest bracket 32 may be connected to the guide rail or the guide groove to slide.

Concretely, the headrest bracket 32 is provided with a first limiting portion 323 that is protruded, and the fixing member 31 is provided with a second limiting portion 314 cooperating with the first limiting portion 323 to limit the headrest bracket 32. When the output rod 11 pushes the linkage member 2 until the first limiting portion 323 abuts against the second limiting portion 314, the headrest bracket 32 is positioned. In other words, the first limiting portion 323 cooperates with the second limiting portion 314 to limit the sliding track of the headrest bracket 32. Specifically, the second limiting portion 314 is disposed between the two sets of rollers 34. The width of the joint of the mounting portion 321 and the curved portion is larger than that of the curved portion, so that the joint cannot pass between the two rollers 34, thereby restricting the sliding track of the headrest bracket 32 in the direction of sliding back. Of course, the first or second limit structure can be used in both directions. Since the linkage member 2 for pushing the headrest bracket 32 is driven by the electric device, it can be started or stopped at any time, so even if the limit structure is not provided at all, normal operation will not be affected.

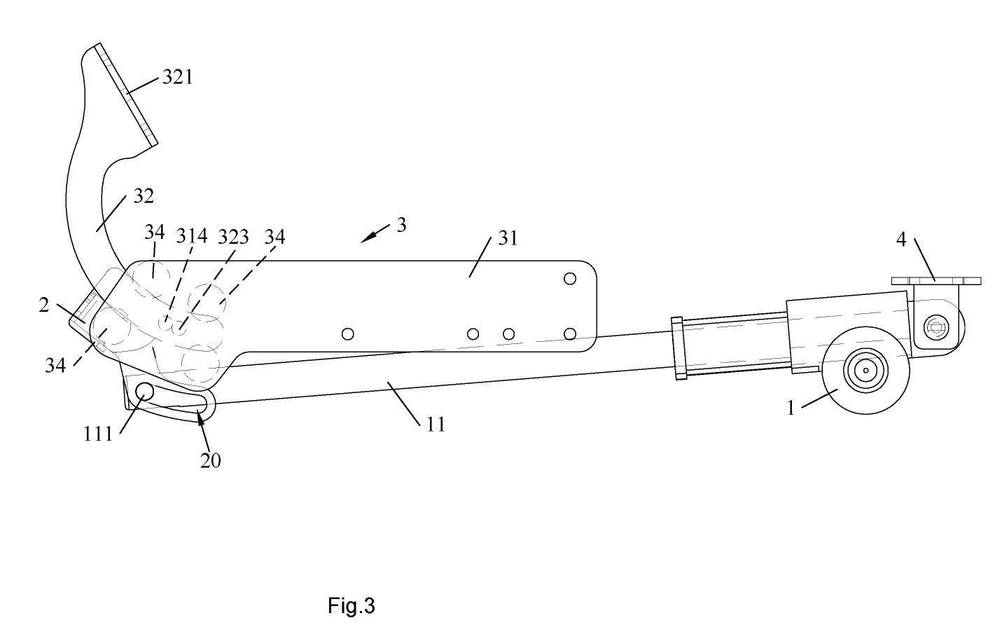

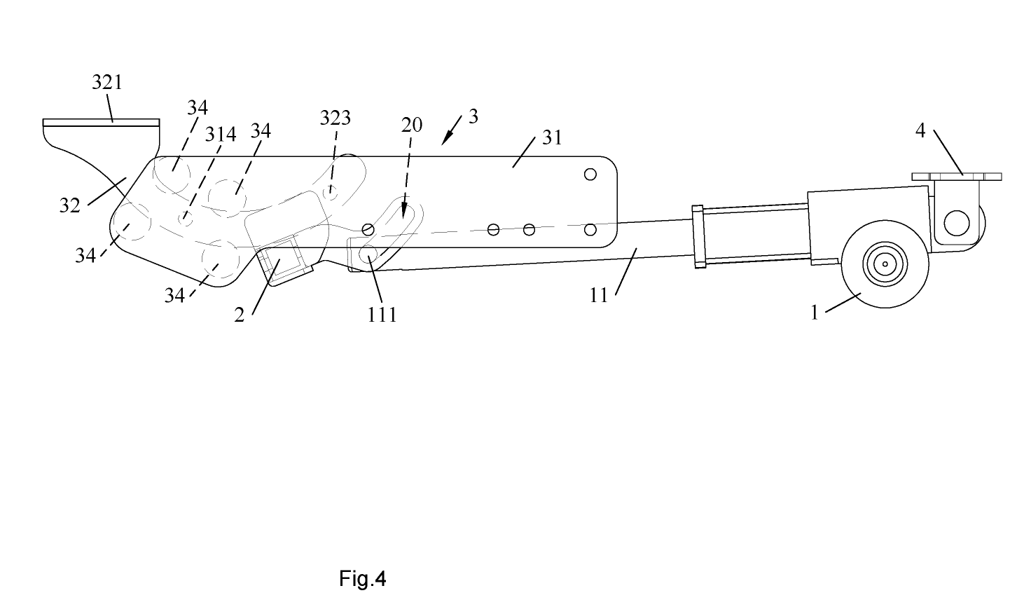

Referring to FIG. 3, the output rod 11 is stretched out to push the linkage member 2 to a farthest position from the fixing base 4. At this time, the first limiting portion 323 abuts against the second limiting portion 314, the mounting portion 321 of the headrest bracket 32 is located at a topmost position, and the angle between the headrest bracket 32 and the horizontal plane is the largest. The output rod 11 moves back to drive the headrest bracket 32 to slide downward by the linkage member 2 until the linkage member 2 reaches a position closest to the fixing base 4, as shown in FIG. 4. At this time, the angle between the headrest bracket 32 and the horizontal plane is the smallest, and the mounting portion 321 reaches a bottommost position. While the headrest bracket 32 is lowered, if one's hand is placed between the headrest and the sofa body, the hand will hinder the headrest to low. As a result, the linkage member 2 will move relatively to the output rod 11, which causes the output rod 11 to slide from one end of the buffer groove 20 to the other end, thereby obtaining a buffering effect. Thus, the headrest is prevented from continuing to descend while the output rod 11 is continuously actuated, thereby effectively preventing the human hand from being pinched and protect one's hand from injury.

Referring to FIGS. 1 and 2, the adjustment assembly 3 further includes an elastic member 36 that is connected between the fixing member 31 and the headrest bracket 32 and provides an elastic force that pulls the headrest bracket 32 back to a bottommost position. Concretely, the elastic member 36 is a tension spring, but not limited to it.

In addition to the sofa, the headrest adjustment device can be installed in other furniture such as seats or beds, and its function is not limited to adjust the headrest, it also can be used for adjusting the angle and height of the backrest.

While the invention has been described in connection with what are presently considered to be the most practical and preferred embodiments, it is to be understood that the invention is not to be limited to the disclosed embodiments, but on the contrary, is intended to cover various modifications and equivalent arrangement included within the spirit and scope of the invention.

What is claimed is:

1. A headrest adjustment device, comprising a linear drive device, a linkage member and an adjustment assembly, the adjustment assembly comprising a fixing member and a headrest bracket movably connected with the fixing member, the linkage member being fixed with the headrest bracket and provided with a buffer groove, the linear drive device having an output rod for linear reciprocating motion, one end of the output rod being connected to one end of the buffer groove, and an angle being formed between the buffer groove and the output rod.

2. The headrest adjustment device according to claim 1, wherein two adjustment assemblies with respective headrest bracket are configured oppositely, and the linkage member is fixed between the two headrest brackets.

3. The headrest adjustment device according to claim 2, wherein the linkage member comprises a linkage rod fixed between the two headrest brackets and a linkage plate fixed on the linkage rod, the buffer groove is defined in the linkage plate, and the linear drive device is located between the two adjustment assemblies.

4. The headrest adjustment device according to claim 1, wherein the fixing member is provided with a guide structure, the headrest bracket is slidably disposed on the fixing member by the guide structure, and a sliding track of the headrest bracket is curved.

5. The headrest adjustment device according to claim 4, wherein the guide structure comprises a plurality of sets of rollers rotatably mounted to a side of the fixing member, and the headrest bracket is curved and inserted into a gap between each set of the rollers.

6. The headrest adjustment device according to claim 5, wherein a guide groove is defined on a circumferential surface of the roller, and the headrest bracket is accommodated between two guide grooves of a set of the rollers.

7. The headrest adjustment device according to claim 4, wherein the headrest bracket is provided with a first limiting portion that is protruded, and the fixing member is provided with a second limiting portion cooperating with the first limiting portion to limit the headrest bracket.

8. The headrest adjustment device according to claim 1, wherein the adjustment assembly further comprises an elastic member located between the fixing member and the headrest bracket, which urges the headrest bracket back to a bottommost position.

9. The headrest adjustment device according to claim 1, wherein the linear drive device is an electric push rod.

10. The headrest adjustment device according to claim 1, further comprising a fixing base, wherein the linear drive device is hinged to the fixing base.
